(19) United States
(12) Patent Application Publication
(10) Pub. No.: US 2008/0245048 A1
(43) Pub. Date: Oct. 9, 2008

(54) Life-link

(76) Inventor: Linda Marie Moore, San Antonio, TX (US)

Correspondence Address: LINDA M. MOORE, 2026 W. SUMMIT AVE, SAN ANTONIO, TX, 78201, US

(21) Appl. No.: 11/784,479

(22) Filed: Apr. 7, 2007

(51) Int. Cl. F16G 13/00

(52) U.S. Cl. 59/80

(57) ABSTRACT

This invention consists of a user customizable jewelry link, having a solid square top, two sides extended downward overturned towards the underside, and having a central opening. This link element, having a unique visual property, was designed to be worn in conjunction with, as a personalized customized addition to, a rubber bracelet.

### BACKGROUND OF THE INVENTION

This present invention was created out of a deep desire to personalize the LIVESTRONG bracelet that I have worn since the onset of my father's illness and which I continue to wear in honor of my father' memory and in support of the many individuals who continue to fight against cancer.

This present invention, which was created to customize and add personal meaning to rubber bracelets worn in support of, is intended to be personalized by engraving on the topside of the jewelry link to indicate a person's initials and/or date of death, or a symbolic meaning. This present invention is to then be slipped over the rubber bracelet by placing one side of the bracelet under one side of the central opening and then pinching the other side of the bracelet in order for it to slip under the other side of the central opening, thereby having a charm-like appearance.

### BRIEF SUMMARY OF THE INVENTION

The present invention relates to the personal and emotional aspect of an individual's life, whose experiences have included, but not limited to, the loss of a loved one, a battle with a life-threatening disease, and/or the support of a cause, such as cancer.

An objective of the present invention is to honor the memory of those individuals who have courageously fought against, but who have lost their battle against a disease, such as cancer.

A further objective of the present invention is to support those individuals who continue to fight against and have presently won their battle against a disease, such as cancer.

A still further objective of the present invention is to serve as a reminder to live stronger lives and to support and fight against life-threatening diseases, such as cancer.

An additional objective of the present invention is to honor the memory of those individuals who have served and given their lives for our country.

### BRIEF DESCRIPTION OF THE SEVERAL VIEWS OF THE DRAWINGS

In the drawings:

FIG. 1 is a perspective view of the life-link.

FIGS. 2a, 2b, 2c, and 2d are illustrations showing various views of the life-link

### DETAILED DESCRIPTION OF THE INVENTION

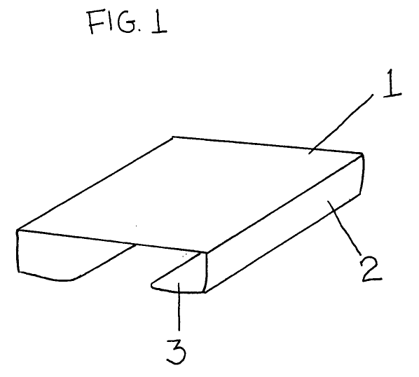

Referring initially to FIG. 1, the life-link is comprised of a precious metal, measuring approximately 1 inch by ½ inch, having a solid flat square top 1 for which engraving is to be placed. Each top corner having a slightly rounded appearance when sides 2 are bent to extend downward before curving toward the underside. The underside, having a central opening, consists of two separate sides 3 having rounded corners and made to secure the life-link onto the rubber bracelet.

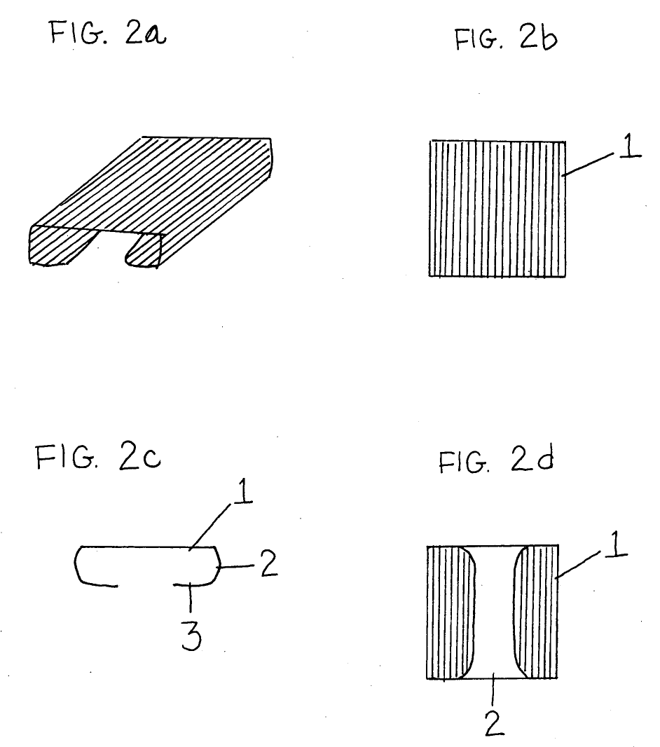

FIG. 2a is a shaded view of the overall shape of the life-link comprised of a precious metal, with a total measurement of 1 inch by ½ inch. FIG. 2b is a top 1 view of the life-link constructed to be ½ square after sides are bent downward and undersides are turned under. FIG. 2c is a side view of the life-link showing a side view of the flat top 1, measuring ½ inch, indicating the sides 2 extending downward, measuring 2 cm and depicting the undersides 3, each measuring 3/16 of an inch. FIG. 2d is a shaded view of the underside 1 of the life-link, each side measuring 3/16 of an inch with rounded corners, with a central opening measuring 2/16 of an inch.

FIGS. 1, 2a, 2b, 2c, 2d are comprised of a precious metal, silver, gold, bronze, or copper.

I claim:

1. (canceled)

2. (canceled)

3. An article of jewelry comprising of one or more links worn in conjunction with a silicone (rubber) bracelet. Said bracelet is flexible, circular, and without end, whereupon said link or links are affixed and moved accordingly. Said link to be comprised of a precious metal, whereupon the outer face surface can be engraved.

4. The article of jewelry as claimed in claim 1 whereupon said precious metal is, but not limited to, silver, and gold.

5. The article of jewelry as claimed in claim 1 wherein said link is designed to have an opening such that said opening will accommodate said mentioned silicone bracelet.
